(19) United States
(12) Patent Application Publication
(10) Pub. No.: US 2012/0012577 A1
(43) Pub. Date: Jan. 19, 2012

(54) Microwave Oven Comprising A Rotary Table

(75) Inventors: Rudolf Jussel, Feldkirch-Gisingen (AT); Jürgen Laubersheimer, Buchs (CH); Philipp Kettner, Rankweil (AT)

(73) Assignee: Ivoclar Vivadent, AG, Schaan (LI)

(21) Appl. No.: 13/182,959

(22) Filed: Jul. 14, 2011

(30) Foreign Application Priority Data
Jul. 16, 2010 (EP) 10 169 856.1

(51) Int. Cl. H05B 6/80; H05B 6/78

(52) U.S. Cl. 219/686; 219/762; 219/752

(57) ABSTRACT

A microwave oven for the thermal treatment of at least one dental restoration part comprises a firing chamber inside which the dental restoration part as well as at least one susceptor that may be moved or rotated by means of a drive motor and that substantially is disc-shaped, are disposed, and a microwave radiation source that indirectly heats the dental restoration part with the aid of the susceptor, wherein the susceptor at least partially is microwave-tight and wherein the microwave radiation source is arranged below the susceptor.

### CROSS-REFERENCE TO RELATED APPLICATIONS

This application claims the benefit of European Patent Application No. 10 169 856.1 filed Jul. 16, 2010, which is hereby incorporated by reference in its entirety.

### TECHNICAL FIELD

The invention relates to a microwave oven for the thermal treatment of at least one dental restoration part.

### BACKGROUND

Microwave ovens have been known for a long time. For heating the dental prostheses for example, it is known from DE 41 02 129 A1, which is hereby incorporated by reference, to provide a microwave oven with a rotary table and to introduce the dental prosthesis therein for hardening. In a manner known per se homogenization of the introduced microwave radiation is to be achieved.

Whereas this approach relates to the polymerization of dental prostheses, it has also become known in the dental field to combine a rotary table with a susceptor, for which reason reference is made to WO 96/41500, which is hereby incorporated by reference.

Further, it is also known from EP 1 060 713 B1, which is hereby incorporated by reference, to use a rotary table in combination with a susceptor element for the firing of dental ceramics. This approach indeed is a good thing and the use of microwave radiation for the heating of the dental ceramic part represents a significant progress. Despite the use of the rotary table, it would be favorable, however, to still improve the heating curve of the dental ceramic part, in particular in view of the short cycle time that is desired in dental laboratories.

### SUMMARY

The invention is based on the object of producing a microwave oven having an improved heating cycle without affecting the heating uniformity.

This object is surprisingly solved by providing a microwave oven having a firing chamber in which a susceptor is disposed, the susceptor may be rotated by a drive motor. The microwave radiation source indirectly heats the dental restoration part with the aid of the susceptor, wherein the susceptor at least partially is microwave-tight and the microwave radiation source is arranged below the susceptor. All the claims are hereby incorporated by reference in the specification.

According to the invention, the measure of arranging the microwave radiation source below the at least partially microwave-tight susceptor, surprisingly results in a considerable improvement of the coupling of the microwave source to the susceptor and thus indirectly to the dental material. The susceptor is disc-shaped or, if applicable, comprises a disc having a raised edge. By means of the arrangement of the microwave source below the susceptor, it may be ensured that the emitted radiation first encounters the susceptor and not directly the dental ceramic material. In this way, the preferred indirect heating is ensured in a surprisingly easy manner. The susceptor then heats the dental material that is supported thereon in an extensive manner and in a good thermal connection therewith, the dental material forming the dental restoration part, wherein according to the invention a particularly good field homogenization of the microwave radiation is achieved. The susceptor at the same time inventively acts as a mode stirrer.

The high-temperature resistant receptacle comprises at least one through-hole or a lateral recess through which the temperature measuring element may sense the temperature of the susceptor.

It is to be understood that the coupling is especially favorable in as much as the microwave radiation source is arranged exactly below the susceptor. The radiation source in this connection refers to the outlet of the respective waveguide. However, it is also possible to effect a certain lateral offset so that the radiation source lies below the plane of the susceptor, however slightly radially outside the disc-shaped susceptor. An angle of 45 degrees to the vertical, viewed as from the radial end of the susceptor, readily has the desired effects.

An advantageous design provides that the center of an area of the susceptor relative to the axis of rotation is arranged in a radially offset manner. In this way, the heating uniformity is surprisingly improved, as areas that absorb radiation with different intensity, are periodically exposed to the microwave radiation during rotation, so that partially more intensive and partially less intensive microwave radiation may be conveniently used. In this connection it is to be understood that it is favorable to arrange the microwave radiation source somewhat outside the axis of rotation of the rotary table.

In a modified embodiment, the susceptor substantially has the shape of a pot and thus is at least partially closed. With this solution, the laterally reflected microwave radiation from the susceptor is absorbed and thus serves to heat the dental restoration part before it directly couples to the microwave radiation at an increased temperature of for example 700 or 800° C.

It is to be understood that either a microwave permeable and thin rotary table that for example is made from high-temperature resistant glass, is used, or that the susceptor itself may be formed as a rotary table. The susceptor, for example, may be formed of silicon carbide having a sufficient strength, wherein it is favorable that it also forms a basic load for the microwave impingement of the microwave oven in case of a non-existent dental restoration part.

According to an advantageous embodiment it is provided that the center of an area of the susceptor relative to the axis of rotation of the susceptor is arranged in a radially offset manner thereto.

According to an advantageous embodiment it is provided that the center of an area of the susceptor coincides with the axis of rotation of the susceptor.

According to an advantageous embodiment it is provided that the susceptor is formed as a ring or a disc and/or at least comprises one bearing surface for the dental restoration part.

According to an advantageous embodiment it is provided that the susceptor comprises a circular outer contour or an outer contour that deviates from the circular shape.

According to an advantageous embodiment it is provided that the susceptor comprises at least one susceptor element that extends in parallel to the axis of rotation of the susceptor and that in particular is formed as a ring section.

According to an advantageous embodiment it is provided that the susceptor is formed as a container that in particular is closed at least partially.

According to an advantageous embodiment it is provided that the working temperature range of the microwave oven that in particular exclusively works with microwave radiation, is between room temperature and 2200° C.

According to an advantageous embodiment it is provided that the interior of the microwave oven is sealed in a gas-tight manner and that the microwave oven may be filled with a given gas selected by the user and/or may be evacuated.

According to an advantageous embodiment it is provided that the one or more susceptors is/are firmly connected to the rotary table and even in case of a nonexistent dental restoration part represent a base load for applying microwaves to the microwave oven.

According to an advantageous embodiment it is provided that the susceptor that is connected to the rotary table acts as a mode stirrer.

According to an advantageous embodiment it is provided that the rotary table at the same time is formed as a mode stirrer and is fixedly connected with the susceptor by having the shape of a crucible or bowl for receiving the dental restoration part.

According to an advantageous embodiment it is provided that at least one high temperature resistant contact or support surface is disposed on or within the susceptor, said support surface serving to receive the dental restoration part.

According to an advantageous embodiment it is provided that at least one high temperature resistant support surface that is fixedly arranged within the firing chamber, is disposed above the susceptor, said support surface serving to receive the dental restoration part.

According to an advantageous embodiment it is provided that the susceptor and/or the high temperature resistant support surface and/or the dental restoration part interact with a temperature sensing element, in particular with an optical temperature sensing element, and that in particular the susceptor and/or the drive motor interact with a measuring device for sensing the microwave power.

According to an advantageous embodiment it is provided that the optical temperature sensing element is directed towards the surface of the susceptor and/or the high temperature resistant support surface and/or the surface of the dental restoration part and that the focus of the detecting area of the temperature sensing element lies outside the rotational axis of the drive motor.

According to an advantageous embodiment it is provided that the position of the susceptor is variable by the drive motor in the direction of rotation and/or in the vertical direction in order to minimize the reflecting microwave radiation within the measuring device.

According to an advantageous embodiment it is provided that the temperature sensing element senses the temperature at a specific location or area of the susceptor and/or the high temperature resistant support surface and/or the dental restoration part, and that the drive motor causes the susceptor to rotate at least a few degrees if a deviation from a given set temperature is determined.

According to an advantageous embodiment it is provided that the susceptor remains constant or may be rotated in the same direction or alternately in different directions a limited period of time or at intervals, and/or that the susceptor in particular during its rotation may be vertically adjusted.

According to an advantageous embodiment it is provided that the susceptor has a thermal conductivity of more than 20 W/mK and at least partially comprises a wall thickness of at least 0.5 mm.

According to an advantageous embodiment it is provided that the susceptor in particular is formed in a multi-part design as a bowl or disc or crucible.

According to an advantageous embodiment it is provided that the susceptor is formed to have a disc-shaped structure which is comprised of at least one large-scale or extensive disc and/or several smaller disc-shaped, ring-shaped, rod-shaped or ball-shaped elements that are arranged side by side and/or one above the other.

### BRIEF DESCRIPTION OF THE DRAWINGS

Embodiments of the present invention will be more fully understood and appreciated by the following Detailed Description in conjunction with the accompanying drawings, in which:

FIG. 1 shows a schematic representation of an inventive microwave oven in a first embodiment;

FIG. 2 shows a schematic representation of a further embodiment of microwave oven according to the invention;

FIG. 3 shows a schematic view of a third embodiment of a microwave oven according to the invention;

FIG. 4 shows a schematic view of a fourth embodiment of a microwave oven according to the invention;

FIG. 5 shows a schematic view of a fifth embodiment of a microwave oven according to the invention;

FIG. 6 shows a schematic view of a sixth embodiment of a microwave oven according to the invention;

FIG. 7 shows a schematic view of a seventh embodiment of a microwave oven according to the invention;

FIG. 8 shows a schematic view of an embodiment in which the susceptor for a microwave oven according to the invention has a circular symmetric design relative to the firing chamber and to the axis of rotation;

FIG. 9 shows a view according to FIG. 8, wherein the susceptor, however, is supported in an asymmetric manner relative to the axis of rotation;

FIG. 10 shows a further embodiment in the representation of FIG. 8, wherein a susceptor is employed that is square-shaped in the top view;

FIG. 11 shows a further embodiment of the susceptor in the representation of FIG. 8, wherein the susceptor substantially is dumbbell-shaped, however is supported in a circularly symmetric manner;

FIG. 12 shows a further embodiment of a susceptor in the representation of FIG. 8;

FIG. 13 shows a further embodiment of a ring-shaped susceptor in the representation of FIG. 8; and

FIG. 14 shows a susceptor arrangement in a different embodiment comprising four individual susceptors, and apart from that in the representation according to FIG. 8.

### DETAILED DESCRIPTION

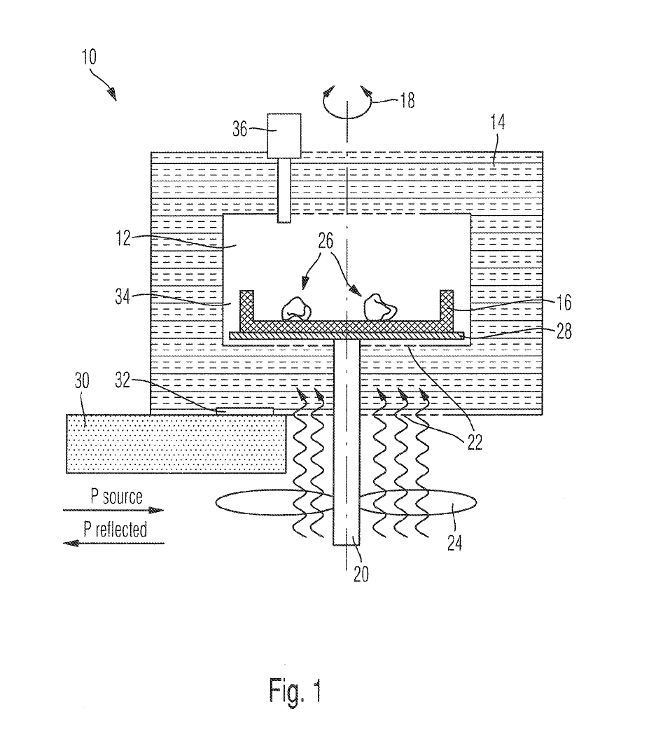

The microwave oven 10 represented in FIG. 1 comprises a firing chamber 12 that is surrounded by heat-insulating material 14. The microwave oven 10 is provided with a drive motor (not shown) that rotates a susceptor 16 about an axis of rotation 18. For this, the drive motor may be arranged on the drive shaft 20, but may also be arranged laterally alongside the drive shaft 20 via a transmission. In the shown example, an air ventilation is provided coaxially with the drive shaft 20, which provides for the supply of air 22 via recesses (not shown) in the material 14, wherein the air ventilation 24 in the drawing according to FIG. 1 is represented schematically. The ventilation 24 is in particularly switched on, in order to provide for a faster cooling after termination of the firing phase, as required, or in order to provide the firing chamber with desired gaseous media during the heat treatment processes.

In the represented exemplary embodiment, the susceptor 16 comprises the shape of a disc or a flat pot. It serves to receive the dental restoration parts 26 schematically represented in FIG. 1. In this exemplary embodiment, the susceptor 16 is arranged on the rotary table 28 in a surface-mounted manner. It is to be understood, however, that the susceptor may also be fixed directly on the drive shaft 20.

According to the invention a microwave radiation source 30 is arranged below the susceptor 16. It comprises a waveguide output 32 and thus applies microwave radiation to the susceptor 16 from below, that is to say from the side, thus preventing the microwave radiation from directly striking the dental restoration parts 26.

In the represented embodiment, there is a slot 34 between the susceptor 16 and the wall of the firing chamber 12. The width of the slot 34 is selected so that a given portion of the microwave radiation may also laterally pass through there, the main portion, however, in any case is forwarded to the susceptor 16.

In a manner known per se, a temperature sensor 36 is provided, for example a pyrometer that measures the temperature of the firing chamber and/or the temperature of the dental restoration parts.

According to the invention it is particularly favorable that also the speed of rotation of the susceptor 16 may be set in any suitable manner. For example, the speed of rotation may amount to between 0, 5 and 70 rotations per minute, and it is also possible to implement a non-constant or clocked speed of rotation that may also be provided in both directions of rotation.

The maximum temperature for firing the dental ceramic material that may be reached in this way, amounts to 2200° C. It is also particularly favorable that the rotary table 28 is formed in such a way that is acts as a mode stirrer for the supplied microwaves. The susceptor, on the other hand, preferably comprises a very high thermal conductivity of at least 20 W/mK and preferably consists of silicon carbide and/or zirconium oxide and/or a mixture of SiC and SiNi.

In order to minimize the reflected microwave energy (P reflected) relative to the supplied microwave energy (P source), the position of the susceptor may be varied in the direction of rotation and/or in the vertical direction.

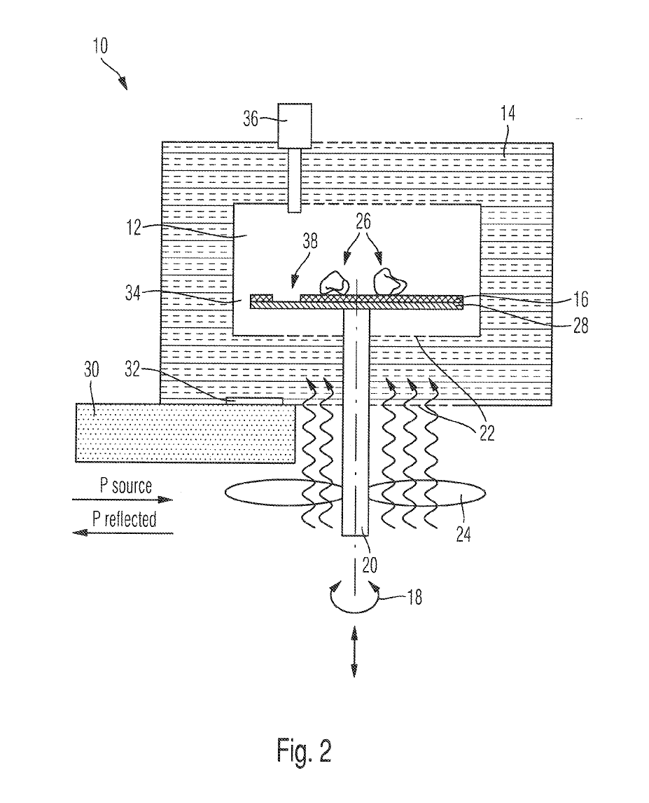

The further embodiments according to FIGS. 2 to 7 substantially comprise the same basic design compared to the embodiment of FIG. 1, wherein the same reference numerals refer to the same components.

The second embodiment according to FIG. 2 comprises a flat, disk-shaped rotary table 28 on which a susceptor 16 is mounted that is as well flat and disk-shaped.

The rotary table 28 is supported on the drive shaft 20 that in this exemplary embodiment may also be displaced in vertical direction apart from its rotability about the axis thereof.

In this arrangement, the susceptor 16 that forms a high-temperature stable receiving section, comprises at least one through-opening 28, and the dental restoration parts 26 are supported next to the through-opening 38 on the high-temperature-stable receiving section.

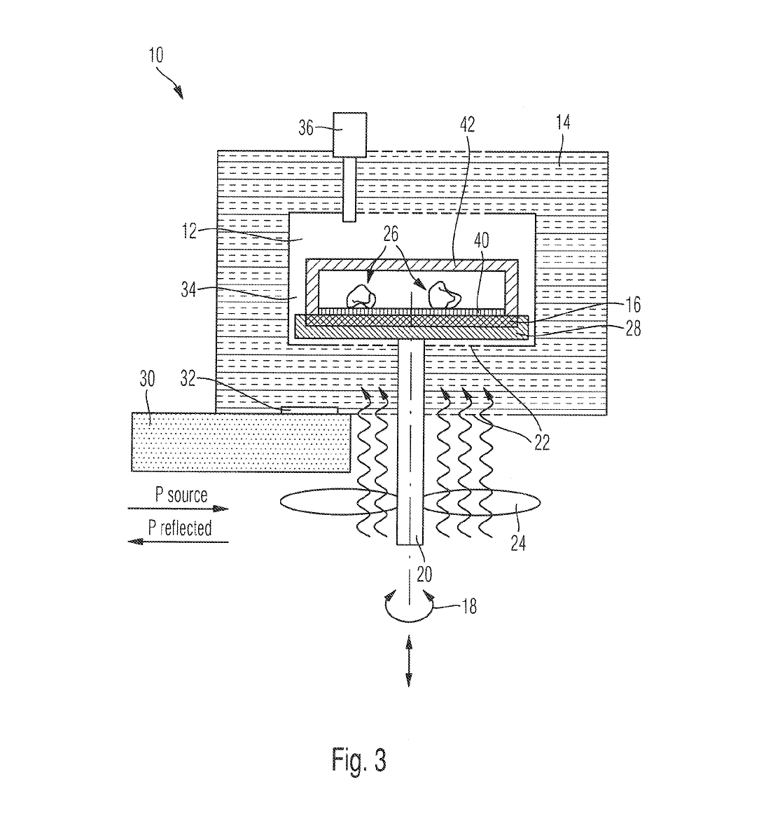

In contrast thereto, in the representation of FIG. 3 it is provided that the susceptor 16 is formed in two parts. A first part is of planar or flat configuration and is received within a recess of the rotary table 28. It is covered by a separate high-temperature stable receiving section 40 on which the dental restoration parts 26 are arranged.

In addition to the pot-shaped design of the susceptor 16 according to FIG. 1, FIG. 3 provides a susceptor cap 42 that is flush with the susceptor element 16 and together with it surround a space that is destined to receive the dental restoration parts 26.

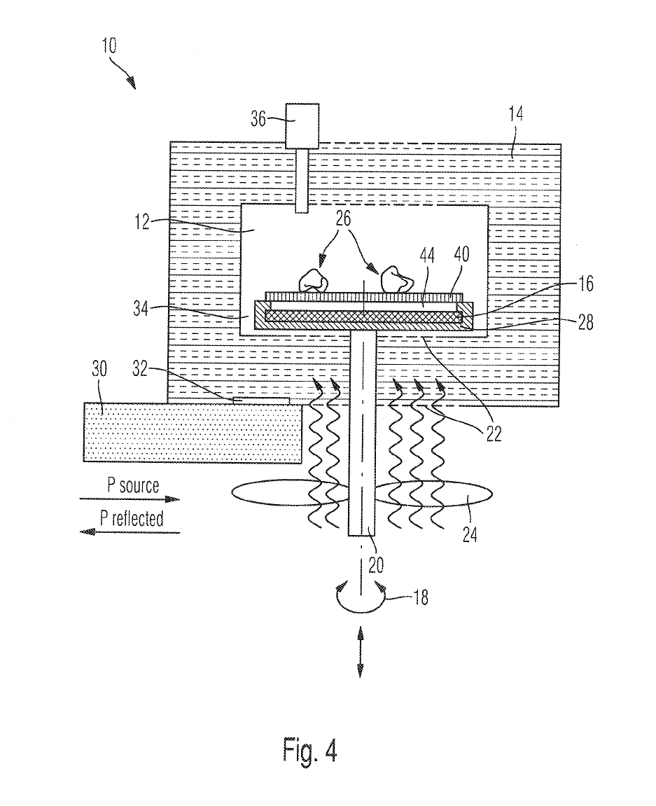

The fourth embodiment of FIG. 4 also comprises a planar or flat susceptor 16. In this embodiment, the susceptor 16 is received within the rotary table 28 in a recessed manner. On the edge of the rotary table 28 the high-temperature stable receiving section 40 that receives the dental restoration parts 26, is supported so as to leave an air space 44 towards the susceptor 16.

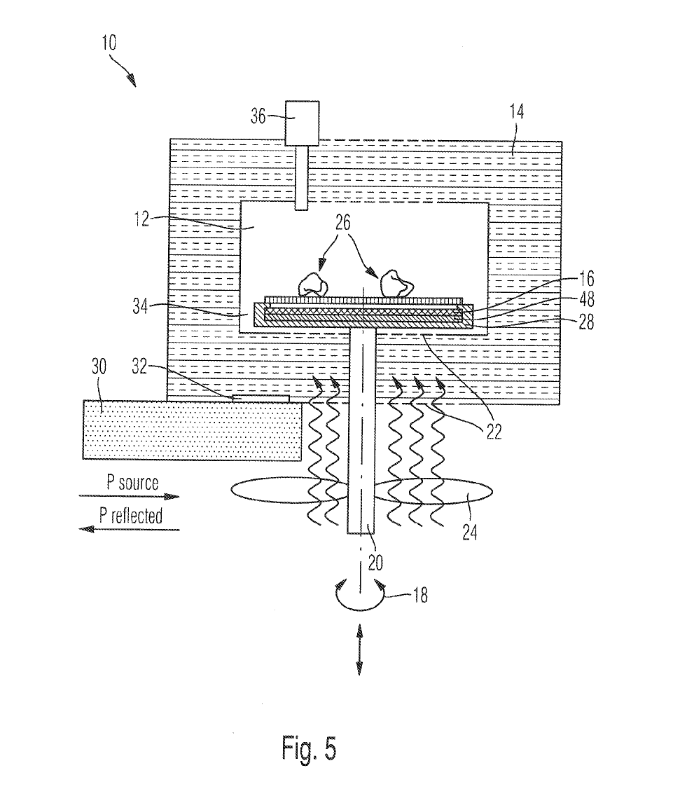

The fifth embodiment of FIG. 5 differs from the fourth embodiment in that the susceptor 16 that is arranged in a recessed manner as well, is provided with an additional susceptor 48 that extends below the susceptor 16 and consists of individual susceptor structures such as discs, rings, rods etc., wherein it is also possible to employ a susceptor granulate.

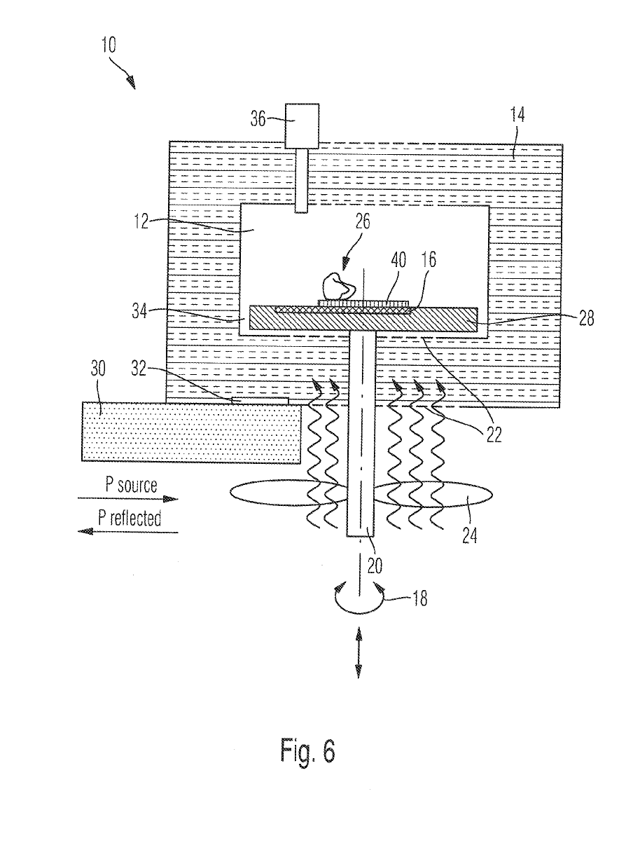

An asymmetric embodiment of the susceptor 16 on the rotary table 28 becomes apparent from the sixth embodiment according to FIG. 6. In this embodiment, the susceptor is received within the rotary table 28 in a recessed manner, wherein the surfaces of the rotary table and the susceptor are flush. Merely in the middle portion of the susceptor, a high-temperature stable receiving section 40 is provided that is destined to receive the dental restoration parts.

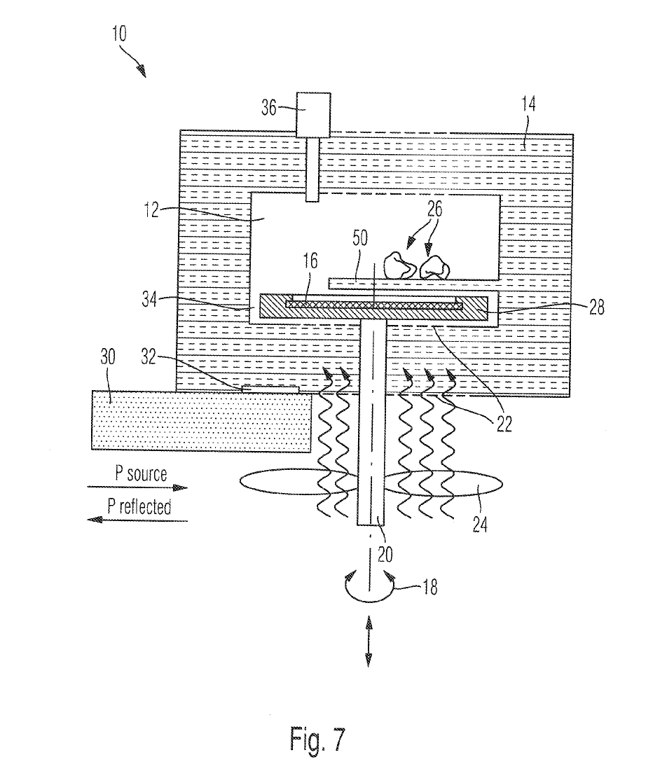

The embodiment according to FIG. 7 differs from the remaining embodiments in that the dental restoration parts are supported on a support member 50 fixed to the oven, said support member 50 extending over the rotary table 28 and the susceptor 16 laterally alongside the heat insulation material 14 of the firing chamber 12. The extension takes place as far as possible, and in the represented exemplary embodiment in an asymmetric manner over somewhat more than half of the diameter of the rotary table 28.

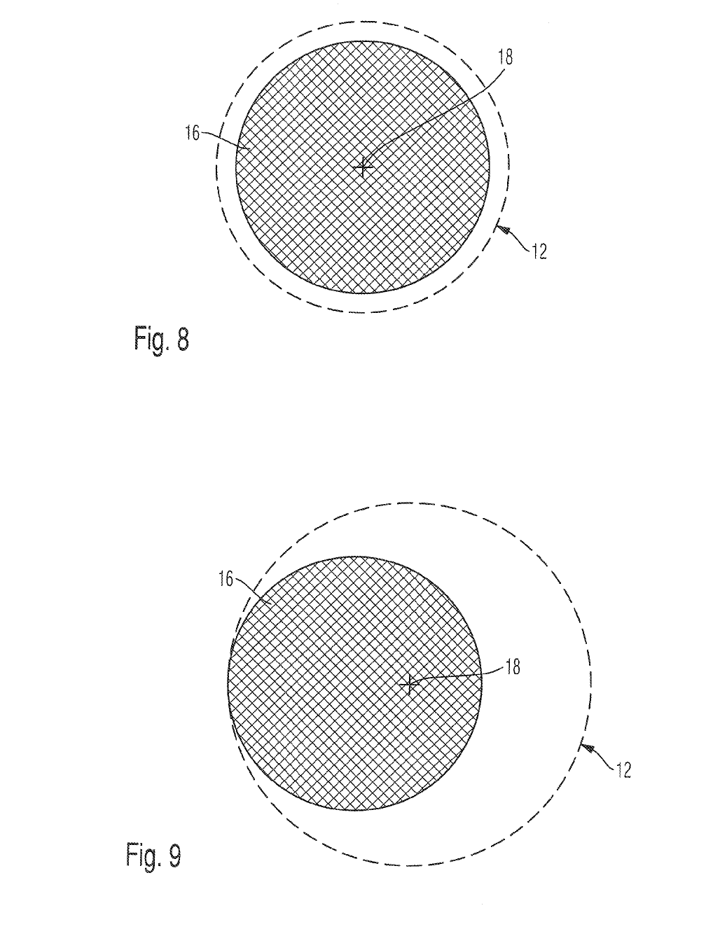

From FIG. 8 it becomes apparent, in which manner the susceptor 16, for example in the embodiments according to FIG. 1 or 3, may extend in the firing chamber 12. In this embodiment, the susceptor in the top view is a circular disk that circulates or rotates around the axis of rotation 18.

According to FIG. 9 a further embodiment of a susceptor 16 is shown which has an asymmetrically mounted configuration of the susceptor 16. The susceptor 16 in this embodiment extends to the inner diameter of the firing chamber 12 and for example comprises a diameter of ⅗ of the inner diameter of the firing chamber 12.

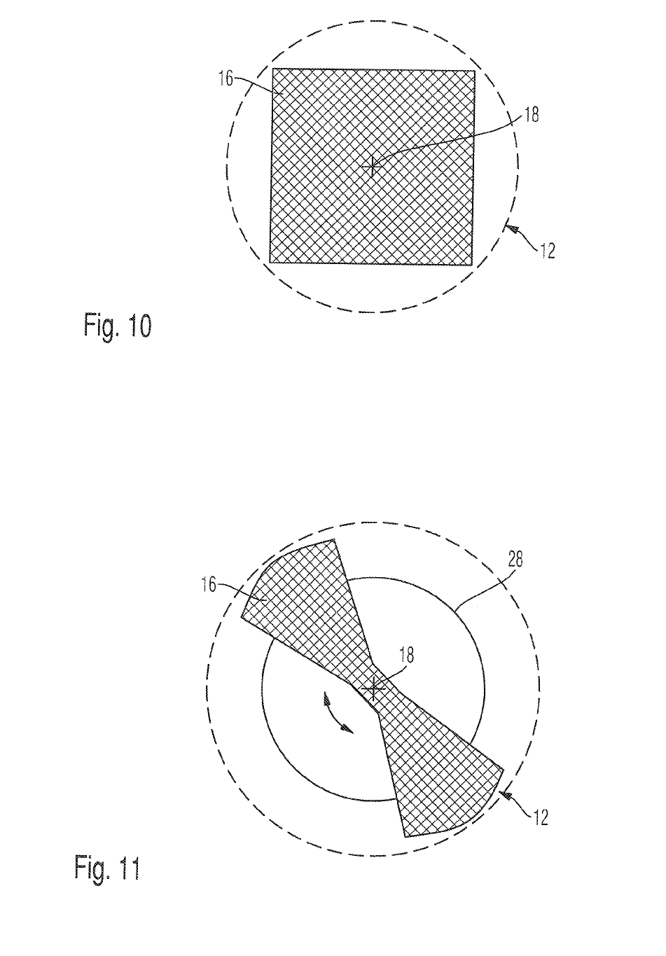

A symmetric configuration of a susceptor 16 becomes apparent from the embodiment of FIG. 10. In this embodiment, the susceptor 16 is square-shaped and supported on the axis of rotation in a symmetric manner.

The susceptor 16 according to FIG. 11 is also supported in a symmetric manner. This susceptor is formed according to the type of a propeller so that its rotary motion relative to the restoration part situated thereabove alternately generates a shadowing effect and exposure.

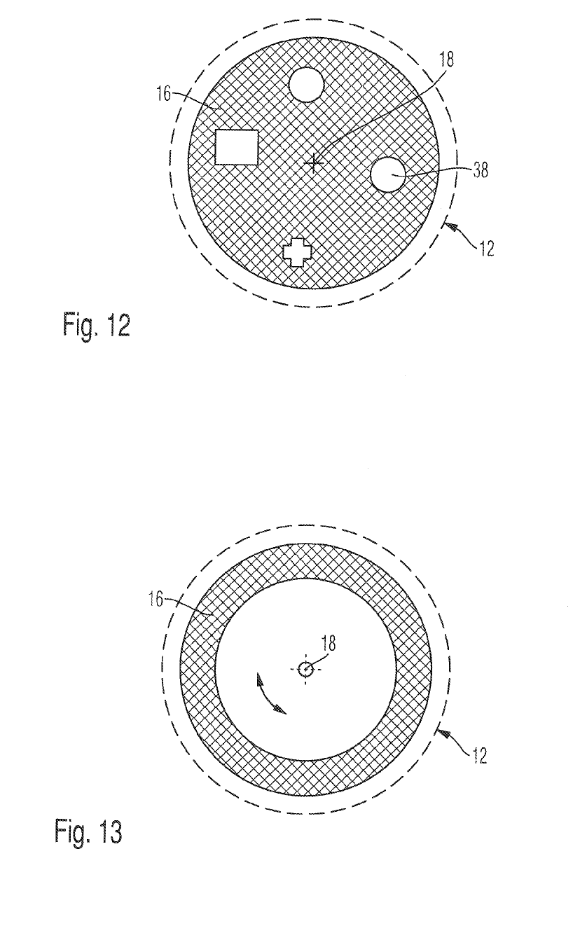

According to FIG. 12, a plurality of through-openings 38 that also may be shaped differently, is provided that extends over the susceptor 16 in a distributed manner, wherein the susceptor by the way is formed in a circular manner and is symmetrically supported on the axis of rotation 18.

According to FIG. 13, the susceptor 16 is formed so as to be ring-shaped and extends along the oven wall of the firing chamber 12, but is supported symmetrically about the axis of rotation.

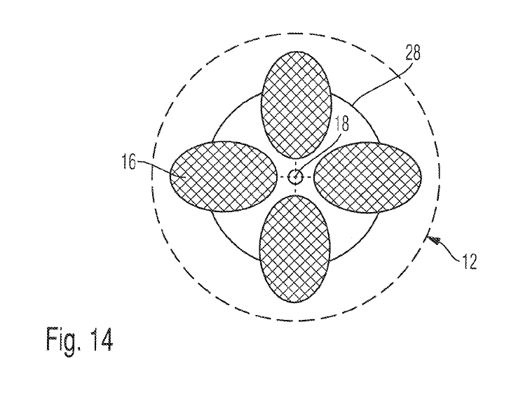

The embodiment according to FIG. 14 shows a multiple arrangement of susceptors 16 that rest on the rotary table 28. The arrangement is symmetrical about the axis of rotation 18, and the susceptors 16 are formed in the represented embodiment substantially according to the type of a four-leaf clover.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed is:

1. A microwave oven for the thermal treatment of at least one dental restoration part, comprising:
a firing chamber inside which the dental restoration part as well as at least one susceptor that may be rotated by means of a drive motor, are disposed, and
a microwave radiation source that indirectly heats the dental restoration part with the aid of the susceptor,
wherein the susceptor at least partially is microwave-tight and the microwave radiation source is arranged below the susceptor.

2. The microwave oven as claimed in claim 1, wherein the center of the area of the susceptor in relation to the axis of rotation of the susceptor is arranged in a radially offset manner thereto, or coincides with the axis of rotation of the susceptor.

3. The microwave oven as claimed in claim 1, wherein the susceptor has the shape of a ring or a disc or at least comprises one bearing surface for the dental restoration part.

4. The microwave oven as claimed in claim 1, wherein the susceptor has the shape of a ring or a disc and at least comprises one bearing surface for the dental restoration part.

5. The microwave oven as claimed in claim 1, wherein the susceptor comprises a circular outer contour or an outer contour that deviates from a circular shape.

6. The microwave oven as claimed in claim 1, wherein the susceptor is formed as a container that is closed at least partially.

7. The microwave oven as claimed in claim 1, wherein the working temperature range of the microwave oven that exclusively works with microwave radiation, is between room temperature and 2200° C.

8. The microwave oven as claimed in claim 1, wherein the interior of the microwave oven is sealed in a gas-tight manner and wherein the microwave oven may be filled with a given gas selected by the user or may be evacuated.

9. The microwave oven as claimed in claim 1, wherein the interior of the microwave oven is sealed in a gas-tight manner and wherein the microwave oven may be filled with a given gas selected by the user and may be evacuated.

10. The microwave oven as claimed in claim 1, wherein the one or more susceptors is/are firmly connected to a rotary table and in case of a nonexistent dental restoration part represent a base load for applying microwave to the microwave oven.

11. The microwave oven as claimed in claim 1, wherein the susceptor that is connected to a rotary table acts as a mode stirrer.

12. The microwave oven as claimed in claim 1, wherein at least one high temperature resistant contact or support surface is disposed on or within the susceptor, said support surface serving to receive the dental restoration part.

13. The microwave oven as claimed in claim 1, wherein at least one high temperature resistant support surface is fixedly arranged within the firing chamber and is disposed above the susceptor, said support surface serving to receive the dental restoration part.

14. The microwave oven as claimed in claim 1, wherein the susceptor and a high temperature resistant support surface and the dental restoration part interact(s) with a temperature sensing element, and wherein the susceptor and the drive motor interact(s) with a measuring device for sensing the microwave power.

15. The microwave oven as claimed in claim 14, wherein the temperature sensing element comprises an optical temperature sensing element.

16. The microwave oven as claimed in claim 1, wherein the susceptor or a high temperature resistant support surface or the dental restoration part interact(s) with a temperature sensing element, and wherein the susceptor or the drive motor interact(s) with a measuring device for sensing the microwave power.

17. The microwave oven as claimed in claim 16, wherein the temperature sensing element comprises an optical temperature sensing element.

18. The microwave oven as claimed in claim 15, wherein the optical temperature sensing element is directed towards the surface of the susceptor and the high temperature resistant support surface and the surface of the dental restoration part and in wherein the focus of the detecting area of the temperature sensing element lies outside a rotational axis of the drive motor.

19. The microwave oven as claimed in claim 15, wherein the optical temperature sensing element is directed towards the surface of the susceptor or the high temperature resistant support surface or the surface of the dental restoration part and wherein the focus of the detecting area of the temperature sensing element lies outside a rotational axis of the drive motor.

20. The microwave oven as claimed in claim 1, wherein the position of the susceptor is variable by the drive motor in the direction of rotation and in the vertical direction in order to minimize the reflecting microwave radiation within the measuring device.

21. The microwave oven as claimed in claim 1, wherein the position of the susceptor is variable by the drive motor in the direction of rotation or in the vertical direction in order to minimize the reflecting microwave radiation within the measuring device.

22. The microwave oven as claimed in claim 1, wherein a temperature sensing element senses the temperature at a specific location or area of the susceptor and the high temperature resistant support surface and the dental restoration part, and wherein the drive motor causes the susceptor to rotate at least a few degrees if a deviation from a given set temperature is determined.

23. The microwave oven as claimed in claim 1, wherein a temperature sensing element senses the temperature at a specific location or area of the susceptor or the high temperature resistant support surface or the dental restoration part, and wherein the drive motor causes the susceptor to rotate at least a few degrees if a deviation from a given set temperature is determined.

24. The microwave oven as claimed in claim 1, wherein the susceptor remains constant or may be rotated in the same direction or alternately in different directions a limited period of time or at intervals, and wherein the susceptor, during its rotation, may be vertically adjusted.

25. The microwave oven as claimed in claim 1, wherein the susceptor remains constant or may be rotated in the same direction or alternately in different directions a limited period of time or at intervals, or wherein the susceptor, during its rotation, may be vertically adjusted.

26. The microwave oven as claimed in claim 1, wherein the susceptor has a thermal conductivity of more than 20 W/mK and at least partially comprises a wall thickness of at least 0.5 mm.

27. The microwave oven as claimed in claim 1, wherein the susceptor is formed in a multi-part design as a bowl or disc or crucible.

28. The microwave oven as claimed in claim 1, wherein the susceptor is formed to have a disc-shaped structure which is comprised of at least one large-scale or extensive disc and several smaller disc-shaped, ring-shaped, rod-shaped or ball-shaped elements that are arranged side by side and one above the other.

29. The microwave oven as claimed in claim 1, wherein the susceptor is formed to have a disc-shaped structure which is comprised of at least one large-scale or extensive disc or several smaller disc-shaped, ring-shaped, rod-shaped or ball-shaped elements that are arranged side by side or one above the other.
